(19) United States
(12) Patent Application Publication
(10) Pub. No.: US 2023/0354755 A1
(43) Pub. Date: Nov. 9, 2023

(54) CLADDING ELEMENT, BUILDING CLADDING SYSTEM AND METHOD OF AIR PURIFICATION

(71) Applicant: Nicholas Yacoub Swami NAIDU, London (GB)

(72) Inventors: Nicholas Yacoub Swami NAIDU, London (GB); James SOUTHALL-ANDREWS, Dorkin (GB); William HUNT, Chorleywood Hertfordshire (GB)

(21) Appl. No.: 18/004,923

(22) PCT Filed: Jul. 12, 2021
(86) PCT No.: PCT/GB21/51782

§ 371 Date: Jan. 10, 2023

(30) Foreign Application Priority Data
Jul. 10, 2020 (GB) 2010635.7
Sep. 10, 2020 (GB) 2014247.7

(51) Int. Cl. A01G 9/02; E04F 13/072

(52) U.S. Cl. CPC A01G 9/025; E04F 13/072

(57) ABSTRACT

A cladding element, for a building cladding system, includes an air filtration panel. The air filtration panel includes at least one channel providing an airflow path from a first opening of the channel to a second opening of the channel and a growing medium is arranged to support the growth of vegetation thereon. The growing medium is positioned such that, in use, airflow through the channel from the first opening to the second opening is directed through or across vegetation supported by the growing medium.

### CROSS-REFERENCE TO RELATED APPLICATIONS

See Application Data Sheet.

### STATEMENT REGARDING FEDERALLY SPONSORED RESEARCH OR DEVELOPMENT

Not applicable.

### THE NAMES OF PARTIES TO A JOINT RESEARCH AGREEMENT

Not applicable.

### INCORPORATION-BY-REFERENCE OF MATERIAL SUBMITTED ON A COMPACT DISC OR AS A TEXT FILE VIA THE OFFICE ELECTRONIC FILING SYSTEM (EFS-WEB)

Not applicable.

### STATEMENT REGARDING PRIOR DISCLOSURES BY THE INVENTOR OR A JOINT INVENTOR

Not applicable.

### BACKGROUND OF THE INVENTION

### 1. Field of the Invention

The present invention relates to a building cladding system and in particular, but not exclusively, a building cladding system for use in high-rise architectural structures and in urban environments.

### 2. Description of Related Art Including Information Disclosed Under 37 CFR 1.97 and 37 CFR 1.98

High and increasing levels of pollution within cities and urban environments has been a severe problem for many years due to the detrimental effects caused to the environment and to public health. At the same time, increasing levels of development in cities and urban environments has significantly reduced the area available for green spaces. However, the beneficial effects of plants and other vegetation for establishing a stable environment and reducing levels of pollution is well known. Not only does such vegetation reduce levels of gases such as carbon dioxide and nitrogen dioxide (amongst others) within the atmosphere but also provide filtration of fine dust and other particulates. There is therefore a desire for creative solutions for increasing the amount of green space and vegetation within cities, without compromising the ability to develop the built environment.

### BRIEF SUMMARY OF THE INVENTION

The present invention seeks to address the abovementioned problems.

According to a first aspect of the present invention there is provided a cladding element for a building cladding system, the cladding element comprising an air filtration panel, the air filtration panel comprising:

at least one channel providing an airflow path from a first opening of the channel to a second opening of the channel; and

a growing medium arranged to support the growth of vegetation thereon,

wherein the growing medium is positioned such that, in use, airflow through the or each channel from the first opening to the second opening is directed through or across vegetation supported by the growing medium.

Preferably, the growing medium is positioned such that, in use, said vegetation supported by the growing medium is recessed from an outer face of the air filtration panel, such that said vegetation is shielded in at least one direction.

The present invention can be used within an architectural cladding system to be applied to buildings in cities and other urban environments, wherein vegetation can be incorporated into the “skinning” of the built environment. The cladding element of the present invention utilises space on buildings, which would otherwise be wasted, to provide air purification by means of vegetation growing on the growing medium. Air which is drawn through the or each channel is directed through or across the vegetation, thus providing purification by at least filtration of particulates and depletion of gases such as carbon dioxide through photosynthesis.

The air filtration panel preferably comprises a plurality of channels providing an airflow path from a first opening to a second opening thereof.

The at least one channel may extend through the air filtration panel so as to provide an airflow path from a first side of the air filtration panel to a second side of the air filtration panel, such that, in use, air flowing through the or each channel from the first side of the air filtration panel to the second side of the air filtration panel is directed through or across vegetation supported by the growing medium.

In the context of the present invention, the first side of the air filtration panel is to be understood as the side which, when the cladding element is attached to a building, lies distal to the building, thus defining and outwardly-facing face (i.e. an outer face) of the air filtration panel. The second side of the air filtration panel is to be understood as the side which, when the cladding element is attached to a building, lies proximal to the building, thus defining and inwardly-facing face (i.e., an inner face) of the air filtration panel. In this context, it will be appreciated that the term “face” is not necessarily limited to a substantially continuous and/or substantially planar surface and may be defined by the outermost point or points (i.e. a distal point) of the air filtration panel, relative to the building, when the cladding element is attached to a building. For example, the or each channel may protrude outwardly such that the outer face of the air filtration panel is defined by a distal edge or edges of the channel. Thus, in some embodiments, the growing medium is positioned relative to the or each channel such that, in use, vegetation supported by the growing medium is recessed from a distal edge of the or each channel, which distal edge may at least partially define a first opening of said channel.

In some embodiments of the present invention, the growing medium of the air filtration panel is air permeable and is positioned such that, in use, airflow from the first opening to the second opening passes through the growing medium. Accordingly, the growing medium can be positioned so as to ensure that airflow is directed through vegetation growing on the growing medium. The growing medium may be inherently air permeable and/or may be provided with perforations or other apertures to permit sufficient air transmittance.

The growing medium may be any medium suitable for growth of vegetation thereon and which provides a physical support for the vegetation. The growing medium may comprise a growing mat, which may be fibre based and/or comprise growing materials such as milled sphagnum, coco fibre, rockwool, porous ceramic soils (such as Turface (registered TM), milled tree fern, cork, expanded glass, cements, or any other suitable growing materials.

A number of techniques may be used to supply necessary moisture to the growing medium to support the growth of vegetation thereon. In some embodiments the growing medium may comprise an absorbent substrate arranged to store water (for example from rainfall) and supply water to the vegetation. The growing medium may comprise a water absorbing layer, which may comprise expanded shale, recycled glass and/or vermiculite or other moisture absorbent materials. The water absorbing layer is capable of storing water, which may then be drawn from the water absorbing layer by the growing mat to hydrate the vegetation.

The cladding element may alternatively or additionally comprise an irrigation system in fluid communication with the growing medium, which irrigation system is capable of storing water and supplying water to the growing medium. Accordingly, the growth of vegetation on the growing medium may be passively irrigated, without the requiring water to be pumped to the growing medium and/or vegetation or manual watering of the vegetation. The irrigation system may comprise a duct system comprising one or more ducts arranged to be fluidly connected to a water tank (or other water source) and the growing medium, such that water can be supplied from the water tank (or other water source) to the growing medium through the duct system, preferably under gravity. The irrigation system may further comprise one or more valves arranged to control the supply of water to the growing medium, which valves may be automatically or manually operated.

The growing medium may comprise an antifungal agent such as activated charcoal and/or another activated carbon material. The provision of an antifungal agent provides resistance to the formation of mould on the cladding element. The antifungal agent may preferably be provided as a layer of the growing medium.

The growing medium may further comprise a mesh barrier to retain the components of the growing medium and to hold the growing medium in place within the cladding element. The mesh barrier may be a wire mesh.

The cladding elements may further comprise one or more sensors for monitoring the ambient conditions in the vicinity of the growing medium to ensure that optimal conditions for growth of vegetation can be maintained. For example, the cladding element may comprise one or more temperature, humidity and/or light sensors. The sensors are preferably provided on or adjacent the growing medium. Where the cladding element comprises an irrigation system, the irrigation system may be configured to control the supply of water to the growing medium in response to signals provided by the one or more sensors. For example, detection of a low level of humidity by a humidity sensor may trigger a signal to be sent to the irrigation system to open a valve permitting the supply of water to the growing medium, either by gravity or under pump action. The cladding element may have a dedicated processing unit configured to receive signals from said one or more sensors and/or to control the operation of an irrigation system in response. However, in preferred embodiments, the sensors are connectable to a central processing unit of a building cladding system comprising a plurality of cladding elements in accordance with the present invention.

The or each channel provides an airflow path from a first opening to a second opening thereof, and thus directs airflow through or across the vegetation. In preferred embodiments, the growing medium is also positioned such that, in use, vegetation growing thereon is recessed from the first opening of the or each channel. Accordingly, the or each channel also provides a recess from the outer face of the air filtration panel. By recessing the vegetation from the first opening of the channel in this way, the vegetation is shielded in at least one direction. That is to say, the vegetation is both shaded from solar radiation incident on the air filtration panel and protected from lateral and/or vertical wind flow which may pass across the outer face of the air filtration panel. By directing the flow of air using the or each channel, wind flow through or across the vegetation can be controlled and regulated, thus limiting potential damage to the vegetation. This arrangement is particularly advantageous where the cladding element is attached to a building at a relatively high altitude, such as on a high-rise building, where the effects of such lateral and vertical wind flow on the vegetation may be more extreme and where maintenance of cladding may be more complicated.

It will be appreciated that the distance by which the vegetation is arranged to be recessed from the outer face will depend on the particular installation and will depend on a number of factors such as the dimensions of the cladding element, the desired amount of sunlight, the particular vegetation in use and the location of the cladding element.

As noted, the or each channel may provide a recess from the outer face of the air filtration panel. In this context, the term recess is to be understood as an area of the air filtration panel which is set back from the outer face of the first side of the air filtration panel. Accordingly, vegetation grown within the recesses is set back (recessed) from the outer face of the first side of the air filtration panel. The recesses defined by the channels may be of any shape, which may be regular or irregular.

The or each channel may be of any form which provides an airflow path from a first opening to a second opening. The or each channel may have a regular or irregular shape and the airflow path defined by the channel may be linear or non-linear.

The or each channel may comprise a first opening at a first side of the air filtration panel, a second opening at or proximal to a second side of the air filtration panel, and one or more walls extending between the first and second openings to define the airflow path from the first side of the air filtration panel to the second side of the air filtration panel. Accordingly, air may enter through the first opening and be directed through the second opening by the wall or walls of the channel.

The wall or walls of the or each channel may be substantially linear between the first and second openings, for example where the channel has a substantially cylindrical, conical, pyramidal or cuboidal form. Alternatively, the wall or walls may be non-linear between the first and second openings and may have an irregular shape. For example, the wall or walls may be curved or may undulate between the first and second openings to provide a ‘waveform’ shape.

The first opening of the or each channel may be larger in at least one dimension than the second opening of said channel. This arrangement promotes airflow from the first side of the air filtration panel to the second side of the air filtration panel by the Venturi effect. For example, the or each channel may have the form of a conical or pyramidal frustum (that is, a truncated cone or a truncated pyramid), wherein the first opening forms a ‘base’ of the frustum and the second opening forms a ‘top’ of the frustum, the first opening being larger than the second opening.

The first and second openings may be quadrilateral in shape. Preferably, two corners of the first opening are arranged to be aligned in a vertical direction, in use, and the remaining two corners of the first opening are arranged to be aligned in a substantially horizontal direction, in use. Such an arrangement is particularly beneficial for capturing wind flow across the outer face of the air filtration panel in both lateral and vertical directions, to direct said lateral and vertical wind flow through the channels and thus through vegetation growing on the growing medium. The first and/or second openings may be shaped as a rhombus. The or each channel may be formed as a frustum of a quadrilateral pyramid, wherein the first opening is larger than the second opening.

Preferably, the or each channel is configured to capture wind flow so as to direct said wind flow from the first opening to the second opening. The or each channel is preferably configured to capture lateral wind flow passing across an outer face of the air filtration panel in one or both directions and/or vertical wind flow passing across an outer face of the air filtration panel in one or both directions. It will be appreciated by a person skilled in the art that the channels may have numerous configurations which capture wind flow and thus promote airflow from the first side of the air filtration panel to the second side of the air filtration panel.

The first opening of the channel may have a first side edge and a second side edge opposing the first side edge, the channel being arranged such that, in use, the first side edge projects further than the second side edge in a direction perpendicular to the plane of an external wall of a building to which the cladding element is attached or which is defined by the building cladding system. According to this arrangement, wind flow across the outer face of the air filtration panel in a direction from the second side edge to the first side edge will be captured and directed through the channel.

In one embodiment, in use, the first side edge and the second side edge are opposed in a lateral direction. Such an arrangement is thereby capable of capturing lateral wind flow passing across the outer face of the air filtration panel (i.e. side to side across an outer face of the air filtration panel).

In another embodiment, in use, the first side edge and the second side edge are opposed in a vertical direction. Such an arrangement is thereby capable of capturing vertical wind flow passing across the outer face of the air filtration panel in a vertical direction (i.e. up or down across an outer face of the air filtration panel).

The air filtration panel may comprise a plurality of channels, each arranged to capture wind flow in a different direction. Accordingly, the air filtration panel can be arranged to capture wind flow in multiple directions.

The or each channel may be shaped to promote wind flow there through, as discussed above, for example by having a first opening at a first side of the air filtration panel which is larger than a second opening which is at or proximal to the second side of the air filtration panel. The resulting constriction of air flow at the second opening results in an increase in the speed of air flow at the second opening (according to the Venturi effect), thus drawing air through the channel from the first opening to the second opening. Alternatively, or additionally, the or each channel may comprise a constricted portion between the first and second openings.

Alternatively or additionally, the or each channel may have one or more internal walls configured to direct air flow from the first opening to the second opening. This may be achieved, for example, by the provision of grooves or protrusions in one or more internal surfaces of the or each channel, which may for example have a helical form.

The air filtration panel may be constructed in a number of ways in order to provide one or more channels as described above. For example, the air filtration panel may comprise an external section in which the or each channel is formed, to which the growing medium is subsequently fitted. The external section may be formed as a unitary structure by any appropriate process including, but not limited to, casting, moulding, milling or digital fabrication (e.g. 3D printing). The external section may be formed of any appropriate material, such as a cementitious material or a layered composite material. In some embodiments, the air filtration panel may be formed as a unitary structure from a material suitable for use as a growing medium, such that vegetation can be grown directly on and supported by the unitary structure.

The air filtration panel may comprise at least one shielding member arranged, in use, to project at an oblique angle or at a right angle to a plane of an external wall of a building to which the cladding element is attached or which is defined by the cladding element, wherein a distal edge of the at least one shielding member at least partially defines the outer face of a first side of the air filtration panel. In this context, “distal edge” is to be understood as the edge of the shielding member which, in use, lies outermost relative to the building. The cladding element may be attached to an existing external wall of the building, in which case the at least one shielding member may be arranged, in use, to project at an oblique angle or at a right angle to a plane of said external wall. Alternatively, the cladding element may be attached directly to a structural element of the building such that the cladding element forms the external wall of the building, in which case the plane of the external wall of the building is defined by the cladding element itself.

According to this arrangement, the or each shielding member projects generally outwards from the building. The growing medium may be recessed from the distal edge of the shielding member or members, meaning that the shielding member shields vegetation growing on the growing medium from solar radiation.

The growing medium may preferably be positioned at or towards a proximal edge of the or each shielding member, the proximal edge being the edge of the shielding member which lies, in use, closest to the building. By this arrangement it can be ensured that vegetation growing on the growing medium is recessed from the outer face of the air filtration panel.

The growing medium is preferably positioned such that vegetation growing thereon is positioned, in use, below at least one shielding member. The growing medium may be positioned between two adjacent shielding members. In preferred embodiments, the cladding element comprises a at least two shielding members, wherein the or each channel is defined by opposing surfaces of two adjacent shielding members, wherein the distal edges of said adjacent shielding members in combination define the outer face of the first side of the air filtration panel.

The or each shielding member may preferably comprise an elongate slat, which slat can be arranged to project outwardly from the building so as to shield vegetation, and to extend in a direction parallel to the building in a substantially horizontal, vertical or diagonal direction. Alternative embodiments may comprise one or more shielding member of any appropriate shape and configuration, which comprise, or are arranged to provide, one or more recesses in which vegetation can be grown and shielded by the shielding members. The air filtration panel may comprise a single sheet of material folded, pressed or punched to form the recesses and/or shielding members, with cuts, perforations or other apertures being provided to allow airflow from the first side of the shielding member to the second side of the shielding member.

In some embodiments of the invention, the or each shielding member may be shaped so as to promote airflow through the channel. To achieve this, the or each shielding member may have at least one surface shaped to reduce resistance to air flow across said surface and/or at least one surface shaped to increase resistance to air flow across said surface. The or each shielding member may, for example, have an aerofoil shape.

The or each shielding member may be formed of any appropriate cladding material including, but not limited to, stainless steel, powder-coated and anodised aluminium, concrete (for example glass reinforced concrete), timber or cork.

The or each channel may comprise a first inner surface arranged to lie, in use, substantially parallel to a plane of an external wall of a building to which the cladding element is attached or which is defined by the building cladding system and a second inner surface opposing the first surface, which is arranged to lie at an oblique angle relative to the first inner surface. Preferably, the first inner surface lies proximal to said external wall of the building relative to the second inner surface. Each of the first and second inner surfaces extends between the first opening and the second opening of the channel. The second inner surface being set at an oblique angle relative to the first inner surface allows air flow passing through the channel to be directed towards the first inner surface, which may be provided with a growing medium such that airflow is directed towards vegetation supported by the growing medium.

The first inner surface may comprise openings or apertures arranged to permit airflow to pass through the first inner surface to the second side of the air filtration panel. Accordingly, the arrangement may be used to direct airflow into a building thus providing a passive ventilation system of the building, where airflow into the building is first directed through or across vegetation.

Preferably, the second inner surface is shaped to reduce resistance to air flow across said surface. The second inner surface may have a convex shape. The second inner surface of the channel may be defined by a shielding member, which may have an aerofoil form.

Preferably, the second inner surface is set at an angle of 15 to 45 degrees relative to the first inner surface, more preferably at an angle of 20 to 40 degrees, and most preferably at an angle of approximately 30 degrees. This allows the channel to effectively capture wind flow passing across an outer face of the air filtration panel and direct said air flow through the channel.

The air filtration panel may further comprise an airflow guiding portion adjacent the first opening of the or each channel, the airflow guiding portion being arranged to guide airflow into the first opening. The airflow guiding portion may comprise a generally curved surface provided in substantially the same plane as the first inner surface of the channel. Accordingly, the curved surface of the airflow guiding portion may direct airflow generally away from the building and towards the first inner surface of the channel. The airflow is subsequently directed by the first inner surface back towards the second inner surface (by being set at an oblique angle thereto). Accordingly, the arrangement may direct airflow laterally across the building in an undulating fashion. The airflow guiding portion may be provided with a further growing medium.

In some embodiments of the present invention, the cladding element further comprises a backing panel spaced apart from the second side of the air filtration panel so as to define an airflow passage between the air filtration panel and the backing panel, which airflow passage preferably extends in a continuous upward direction, in use.

The airflow passage preferably extends from a bottom edge of the cladding element to a top edge of the cladding element. Preferably, the top edge and bottom edge of the cladding element are arranged to engage with a respective top edge or bottom edge of another identical cladding element, such that respective the airflow passages of the two cladding elements are in fluid communication. Accordingly, the respective airflow passages of two adjoining cladding elements define a shaft, which shaft preferably extends in a continuous, upwards direction. The length of the shaft can be increased by joining further cladding elements above or below. Air within the shaft is warmed by radiation from the building through the backing panel. Warm air may alternatively or additionally be ventilated into the shaft from the building, for example from the exhaust of an air conditioning system. In any case, the structure of the cladding elements creates, in use, a temperature differential between the first side of the air filtration panel and the second side of the air filtration panel. Warm air within the shaft will rise naturally, which creates a convection current in a generally upwards direction through the shaft. The strength of the convention current will increase with the increasing length of the shaft. Where the cladding element has a sufficient height, the airflow passage of a single cladding element may be sufficient to define a shaft producing said convection current. The convection current generated by the warm air within the shaft will act to draw air through the air filtration panel of each cladding element. Accordingly, the arrangement of the cladding element permits passive ventilation of air through the air filtration panel, and thus through the vegetation without the need for mechanical ventilation.

The cladding element may comprise a thermally protective layer positioned between the air filtration panel and the backing panel, the thermally protective layer being air permeable. The thermally protective layer preferably defines the second side of the air filtration panel. The thermally protective layer acts to protect the growing medium from warm air within the shaft. The thermally protective layer may preferably be in the form of a heat sink, arranged to dissipate thermal energy away from the growing medium.

The backing panel preferably comprises an insulating material and is preferably arranged to form a weatherproof seal with the building.

The cladding element may preferably comprise one or more spacers for, in use, spacing the air filtration panel from a structural element of the building to which the cladding element is attached, such as an external wall of the building. Where the cladding element is attached directly to an external wall of the building, the spacers may be used to define an airflow passage between the external wall of the building and the second side of the air filtration panel. Accordingly, the cladding element or cladding elements may define a shaft having the abovementioned benefit, without the need for a backing panel. The spacers may alternatively or additionally space the air filtration panel from a backing panel. The spacers may wholly or partially form a frame surrounding the air filtration panel.

The or each spacer may be in the form of an adjustable bracket arranged to permit the spacing between the air filtration panel and said structural element of the building to be varied.

In some embodiments, the cladding element may comprise a surround having a distal edge sealingly engaged with the second side of the air filtration panel around a periphery of the second side of the air filtration panel, the surround further comprising a proximal edge arranged, in use, to form a seal with an external wall of a building to which the cladding element is attached. In use, the surround provides an airtight barrier between the second side of the air filtration panel and the external wall of the building. Accordingly, the cladding element can be fixed to an external wall, over an external air conditioning unit also fitted to the building, such that the air conditioning unit is completely enclosed by the surround and the air filtration panel, such that air drawn in by or blown out from the air conditioning unit is passed through the air filtration panel. Accordingly, the external air conditioning unit may be used to provide the necessary ventilation through the air filtration panel, without the need for dedicated mechanical ventilation. This has the particular advantage of being able to be retrofitted to buildings in urban environments having externally mounted air conditioning units and thus may be particularly useful in urban domestic environments. The cladding element of such embodiments could be used as a standalone building cladding system arranged to cover a portion of an external wall in which the air conditioning unit is fitted, or could be used in combination with other identical or non-identical cladding elements to form a larger building cladding system covering a wider area of the building façade.

The cladding element may further comprise vegetation supported by the growing medium. The vegetation may preferably comprise a moss. The vegetation may comprise at least one moss selected from the group consisting of:

Cushion mosses

Carpet mosses

Mnium hornum

Rhytidiadelphus squarrosus

Syntrichia ruraliformis

Brachythecium rutabulum

Dicranum scoparium

Hylocomnium splendens

Polytrichum spp

Hypnum cupressiforme

Ceratodon purpureus

Eurynchium sp.

In a second aspect of the present invention, there is provided a building cladding system comprising a first cladding element according to the first aspect of the present invention, wherein the first cladding element is arranged to engage with one or more further cladding elements at a top, bottom or side edge of the first cladding element. The further cladding elements may also be cladding elements according to the first aspect of the present invention. Hereafter, the term “filtration cladding element” will be used to describe a cladding element in accordance with the first aspect of the present invention.

In some embodiments the building cladding assembly may further comprise one or more blank cladding elements arranged to releasably engage with one or more filtration cladding elements at a top, bottom or side edge of the filtration cladding element. The blank cladding elements may be cladding elements of any conventional type, such as single or double skin cladding and may be formed of any appropriate material such as timber, metal (e.g. aluminium), glass, concrete or a composite material. In areas of the building façade in which air permeability is required, the blank cladding elements may arranged to permit airflow through the blank cladding element (that is, the blank cladding elements may be air permeable). For example, the or each blank cladding elements may comprise a louvre or mesh screen. Numerous types of suitable cladding will be known to the skilled person. Accordingly, the building cladding system, when installed on a building façade may have a combination of filtration cladding elements and blank cladding elements of a conventional type.

Preferably, the filtration cladding elements and the blank cladding elements are arranged to be interchangeable with each other, permitting a blank cladding element to be swapped for a filtration cladding element at any stage. This may be advantageous where it is desired to initially construct a building using cladding of a conventional type, whilst retaining the option to replace one or more of the conventional cladding elements with filtration cladding elements at a later stage. For example, an air permeable blank cladding (e.g. comprising a conventional louvre or mesh screen) may initially be installed, which blank cladding element can at a later stage be replaced with a cladding element in accordance with the first aspect of the present invention, in order to provide an air purification and filtering function.

To permit the respective cladding elements to be interchangeable, the one or more filtration cladding elements and the one or more blank cladding elements may have equal dimensions, allowing a single filtration cladding element to be interchanged with a single blank cladding element. Accordingly, the a filtration cladding element can be retrospectively “swapped-in” to the building cladding system by removing a blank cladding element and replacing it with the filtration cladding element. Alternatively, the one or more filtration cladding elements may have a dimension which is a fraction of the corresponding dimension of the one or more blank cladding elements, or vice versa. For example, a filtration cladding element may have a height which is half the height of the blank cladding element and width which is equal to the width of the blank cladding element. Accordingly, two filtration cladding elements may occupy the same area as a single blank cladding element. It will be appreciated that numerous different arrangements are possible which permit facile interchangeability of the filtration cladding elements and the blank cladding elements.

According to a third aspect of the present invention, there is provided a method of providing air purification comprising fitting a cladding element according to the first aspect of the present invention (that is, a “filtration cladding element”), such that said cladding element forms or is adjacent to an external wall of the building, and providing vegetation on the growing medium of the air filtration panel. As described above, air drawn through the air filtration panel from the first side to the second side thereof is thus directed through the vegetation, permitting the vegetation to filter particulates from the ambient air and to extract carbon dioxide. Where the vegetation is a moss, particulates are bound by the branch structures of the moss.

Advantageously, the method further comprises fitting the cladding element to the building so as to define an airflow passage between the second side of the air filtration panel and an external wall the building, or wherein the cladding element comprises a backing panel spaced apart from the second side of the air filtration panel so as to define an airflow passage between the air filtration panel and the backing panel. Accordingly, the airflow passage at least partially defines an upwardly extending shaft, which allows passive ventilation of air through the air filtration panel as described above.

In some embodiments, the cladding element is a first cladding element and the airflow passage is a first airflow passage, the method further comprising fitting a second cladding element to the building so as to define a second airflow passage between the second cladding element and an external wall the building, or wherein the second cladding element comprises a second airflow passage, and wherein the first and second cladding elements are arranged to engage such that the first and second airflow passages are in fluid communication and at least partially define an upwardly extending shaft.

The second cladding element may be a cladding element according to the first aspect of the present invention (that is, a “filtration cladding element”). However, it will be appreciated that the second cladding element may not necessarily comprise an air filtration panel (and thus may not be a “filtration cladding element” in the context of the present invention) but may be used to partially define the shaft, thus facilitating the passive ventilation of air through the air filtration panel of the first cladding element. For example, the second cladding element may comprise a non-permeable front panel spaced from the external wall of the building to define the second airflow passage between the second cladding element and an external wall the building, or the second cladding element may further comprise a backing panel spaced apart from the non-permeable front panel to define the second airflow passage between the backing panel and the non-permeable front panel. Thus, positioning the second cladding element above the first cladding element places the first and second airflow passages in fluid communication to define the shaft, wherein a lower portion of the shaft receives outside air through the air filtration panel of the first cladding element. Any number of such non-permeable cladding elements may also be stacked above the second cladding element to provide a shaft of the desired length and to ensure the necessary convection currents are generated to draw air through the air filtration panel of the first cladding element at a lower portion of the shaft. It will be appreciated that any number and any combination of filtration cladding elements and non-permeable cladding elements may be used according to the specific requirements of the building.

The method may comprise ventilating warm air from the building into the shaft, for example from the exhaust of an air conditioning unit.

In some embodiments, the cladding element is fitted to the building such that the second side of the air filtration panel is in fluid communication with an air intake of the building. The cladding element may preferably be fitted directly over said air intake. In such embodiments, the necessary airflow through the air filtration panel can be generated by existing air intakes of the building to which the cladding element is fitted. Accordingly, it is not necessary for the cladding element to define a shaft for passive ventilation, nor is it necessary to provide a dedicated mechanical ventilation system to provide airflow through the air filtration panels of the cladding element. The method can therefore be used on existing buildings utilising existing air intakes. The air intake may preferably be an air intake of an air conditioning system.

### BRIEF DESCRIPTION OF THE SEVERAL VIEWS OF THE DRAWINGS

Non-limiting embodiments of the present invention will now be described, by way of example only, with reference to the accompanying drawings.

FIG. 1 is a perspective view of a building cladding system comprising a cladding element in accordance with a first embodiment of the present invention.

FIG. 2 is a perspective sectional view of the cladding element of FIG. 1.

FIG. 3 is a cross-sectional view of the cladding element of FIG. 1.

FIG. 4 is a cross-sectional view of a building fitted with the building cladding system of FIG. 1.

FIG. 5 is a perspective view of a building cladding assembly comprising a variation of the cladding element of FIGS. 1 to 4.

FIG. 6 is a perspective sectional view of a cladding element in accordance with a second embodiment of the present invention.

FIG. 7 is a perspective sectional view of a cladding element in accordance with a third embodiment of the present invention.

FIG. 8 is a perspective sectional view of a building cladding assembly comprising a further variation of the cladding element of FIGS. 1 to 4.

FIG. 9 is a perspective view of a building cladding system comprising a plurality of cladding elements in accordance with a fourth embodiment of the present invention, wherein one of the cladding elements is shown in exploded view.

FIG. 10 is a cross-sectional view of the building cladding system of FIG. 7.

FIG. 11 is a perspective view of a cladding element in accordance with a fifth embodiment of the present invention.

FIG. 12 is a perspective view of an air filtration panel for use with a cladding element in accordance with a further embodiment of the present invention.

FIG. 13 is a perspective view of an air filtration panel for use with a cladding element in accordance with a further embodiment of the present invention.

FIG. 14 is a perspective view of a cladding element in accordance with a further embodiment of the present invention.

FIG. 15 is a perspective view of a cladding element in accordance with a further embodiment of the present invention.

### DETAILED DESCRIPTION OF THE INVENTION

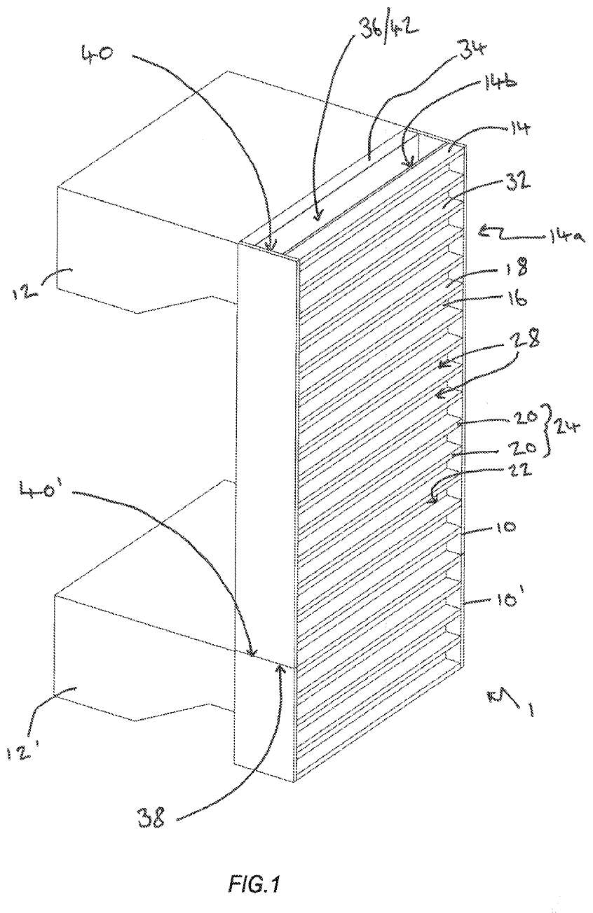

With reference to FIGS. 1 to 4, there is shown a building cladding assembly, indicated generally as 1, comprising plurality of identical cladding elements 10. In the illustrated embodiment, each cladding element 10 is attached directly to an internal floor 12 of the building and thus directly forms a portion of the external wall of the building to which the building cladding assembly 1 is attached. In alternative embodiments, each cladding element 10 may instead be attached to an existing external wall of the building, which may be formed of brick, glass, metal (e.g. aluminium) or any other appropriate material for use on the façade of a building.

Each cladding element 10 comprises an air filtration panel 14 arranged to permit airflow through the air filtration panel 14 from a first side 14a of the air filtration panel 14 to a second side 14b of the air filtration panel 14. The first side 14a of the air filtration panel 14 is the side which, when the cladding element 10 is attached to a building, lies distal to the building. The second side 14b of the air filtration panel 14 is the side which, when the cladding element 10 is attached to a building, lies proximal to the building.

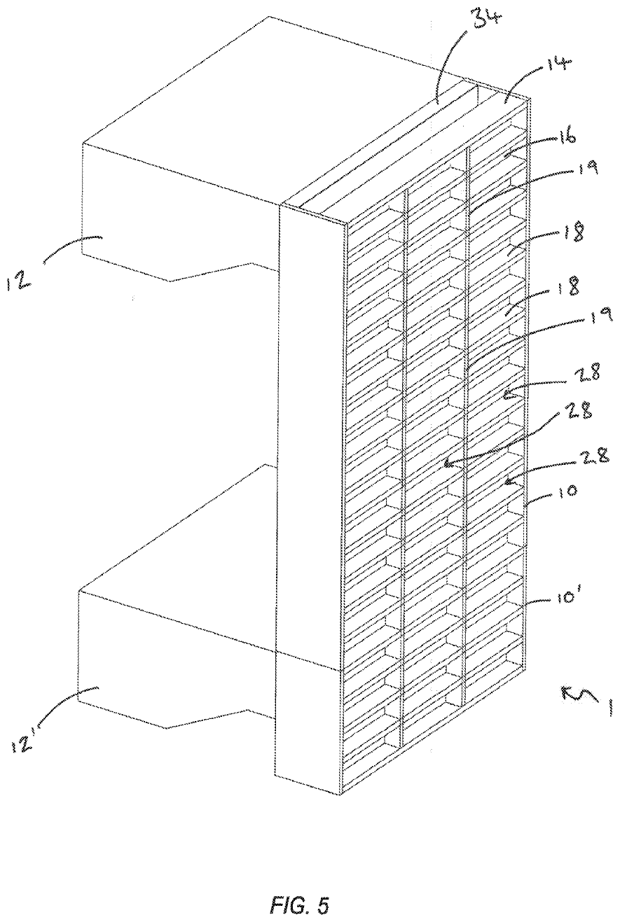

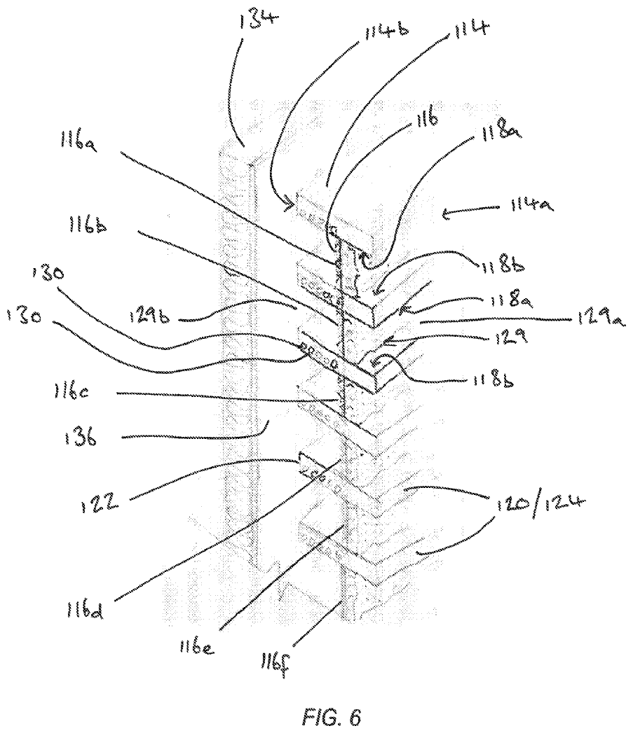

Each air filtration panel 14 comprises a growing medium 16, which is arranged to support the growth of vegetation and which is air permeable, so as to permit the flow of air through the growing medium 16. In the embodiment illustrated in FIGS. 1 to 4, the growing medium 16 is in the form of a growing mat, which may be fibre based and/or comprise growing materials such as milled sphagnum, porous ceramic soils (such as Turface (registered TM)), milled tree fern, cork or any other suitable growing materials. Such materials may be provided alone or in combination, and may be layered. In alternative embodiments, the growing medium 16 may be divided into a plurality of separate portions, as described in greater detail below with reference to the embodiments of FIGS. 5 and 6.

In some embodiments, the growing medium 16 may not be sufficiently air permeable to permit sufficient airflow through the growing medium 16. In such embodiments, it is preferable that the growing medium 16 comprises perforations to allow sufficient air transmittance through the air filtration panel. The growing medium may alternatively or additionally be positioned such that it does not block the entire flow path through the air filtration panel 16, such that sufficient airflow through the air filtration panel 14 is permitted.

A rear surface of the growing medium 16 defines the second side 14b of the air filtration panel 14. In the context of the present specification, the rear surface of the growing medium 16 is to be understood as being the surface of the growing medium which, in use, lies proximal to the building to which the cladding element 10 is attached.

The air filtration panel 14 further comprises a plurality of shielding members 18 in the form of slats, which are arranged, in use, to project substantially at right angles to the plane of an external face of the building, which external face is defined in the illustrated embodiment by the building cladding assembly 1. Each shielding member 18 comprises a distal edge 20 and a proximal edge 22. In combination, the distal edges 20 of the shielding members 18 define an outer face 24 of the first side 14a of the air filtration panel 14.

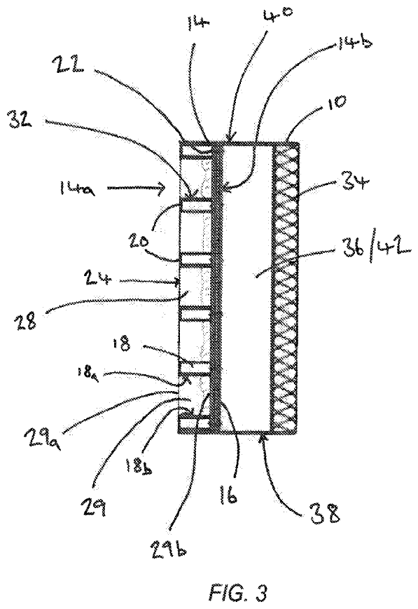

As shown in FIG. 3, the growing medium 16 is positioned such that the vegetation 26 growing on the growing medium 16 is recessed from the outer face 24 of the first side 14a of the air filtration panel 14. In the illustrated embodiment, this is achieved by positioning the growing medium 16 adjacent the proximal edges 22 of the shielding members 18, such that the shielding members 18 extend outwardly from the growing medium 16. Accordingly, the shielding members 18 and the growing medium 16 collectively define a plurality of elongate recesses 28 in the air filtration panel 14, in which vegetation 26 can be grown. Since the growing medium 16 forms a base portion of each of the elongate recesses 28, vegetation 26 can be grown at the base of each elongate recess 28, meaning that the vegetation 26 will be recessed from the outer face 24 of the first side 14a of the air filtration panel 14. By recessing the vegetation 26 from the outer face 24 in this way, the vegetation 26 is both shaded from solar radiation incident on the air filtration panel 14 and protected from wind.

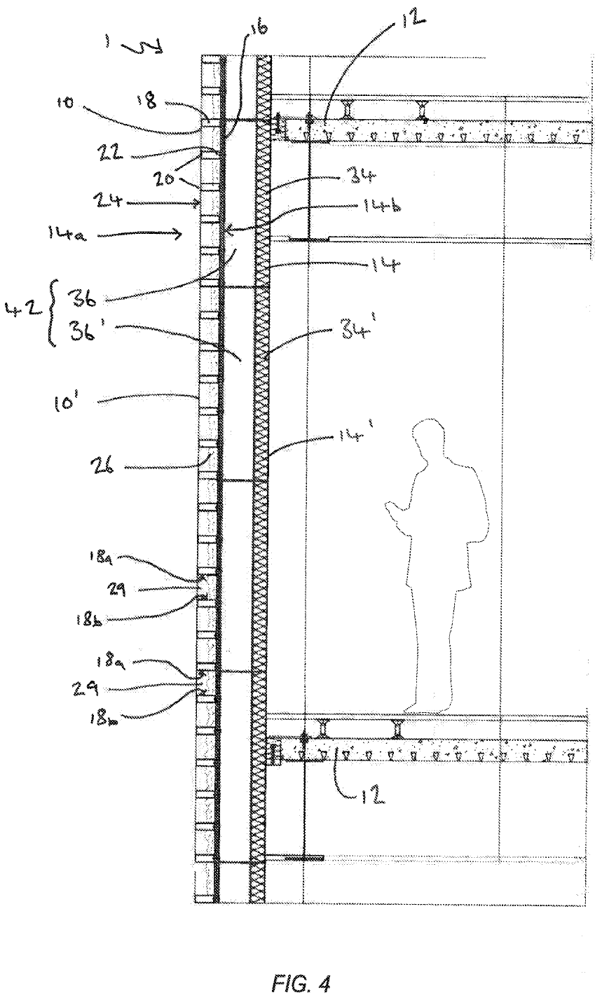

As shown most clearly in FIGS. 3 and 4, opposing surfaces 18a, 18b of each pair of adjacent shielding members 18 define a channel 29 between them, which channel 29 provides an airflow path from the first side 14a to the second side 14b. A first opening 29a of each channel 29 is defined by the two distal edges 20 of each pair of adjacent shielding members 18, the first opening 29a thus being located at the first side 24a of the air filtration panel. A second opening 29b of each channel 29 is defined by the opposing proximal edges 22 of the respective shielding members 18. The growing medium 16 is positioned, such that in use, air flowing through each channel 29 from the first opening 29a to the second opening 29b is directed through vegetation supported by the growing medium 16.

The growing medium 16 is positioned at the rear of each channel 29, such that air flow from the first side 14a of the air filtration panel 14 to the second side 14b of the air filtration panel, through the channels 29 defined by opposing surfaces 18a, 18b of the shielding members 18, must pass through vegetation 26 growing on the growing medium 16. Accordingly, as air passes through the air filtration panel 14, the vegetation 26 provides a natural form of air filtration, removing harmful particulates and other pollutants from the atmosphere surrounding the building to which the building cladding assembly 1 is attached and also providing absorption and removal of carbon dioxide from the surrounding atmosphere through photosynthesis, as well as other polluting gases.

It is preferable that the growing medium 16 is arranged such that all airflow through the air filtration panel 14 is directed through the vegetation 26. Accordingly, in the embodiment of FIGS. 1 to 4, the growing medium 16 covers substantially the entire area defined by the air filtration panel 14. Vegetation 26 can therefore be grown within all of the elongate recesses 28 and along substantially the entire exposed surface area of the growing medium within each elongate recess 28. Accordingly, all airflow directed through the channels 29 of the air filtration panel 14 from the first side 14a to the second side 14b can be directed through the vegetation 26.

It will be appreciated that the air filtration panel 14 may be constructed in a number of different ways which allow for vegetation to be recessed from the outer face 24 of the first side 14a of the air filtration panel 14 and thus protected from sun and wind. For example, whilst in the embodiment shown in FIGS. 1 to 4 the elongate shielding members 18 extend transversely across the width of the air filtration panel 14 in a substantially horizontal orientation in use (i.e. substantially parallel to the floors 12 of the building), the elongate shielding members 18 may alternatively extend longitudinally in a substantially vertical orientation in use (i.e. from a bottom edge to a top edge) or diagonally at an oblique angle. The air filtration panel 16 may equally comprise shielding members extending in multiple orientations. For example, FIG. 5 shows variation of the cladding assembly 10 of FIGS. 1 to 4, modified to comprise a combination of horizontally-extending shielding members 18 and vertically-extending shielding members 19, defining a plurality of elongate recesses 28 in which vegetation can be grown. It will be further appreciated that the recesses formed by the shielding members may not necessarily be elongate and may have any desired shaped defined by the shape and orientation of the shielding members.

In the embodiment of FIGS. 1 to 4, the shielding members 18 project outwardly from the growing medium 16 (i.e. away from the building, in use) at right angles to the plane of the external face of the building. However, in alternative embodiments the shielding members 18 may project outwardly at an oblique angle relative to the plane of the external face of the building. The angle at which the shielding members 18 project outwardly may be variable, such that the angle can be optimised according to the exact location of the cladding element 10.

Still further, in the embodiments of FIGS. 1 to 4, the shielding members 18 lie directly adjacent the growing medium 16 such that the proximal edges 22 of the shielding members 18 are in contact with a front surface of the growing medium 16 (that is, a surface of the growing medium 16 which lies distal to the building, in use), thus defining the elongate recesses 28 between adjacent shielding members 18. However, in alternative embodiments the proximal edges 22 of the shielding members 18 may be spaced apart from said surface of the growing medium 16. It will be appreciated that, in such an arrangement, vegetation 26 growing on the front surface of the growing medium 16 is still recessed from the outer face 24 of the first side 14a of the air filtration panel 14 (which outer face 24 is defined by the distal edges 20 of the shielding members 18) and is therefore protected from solar radiation and wind by the shielding members 18.

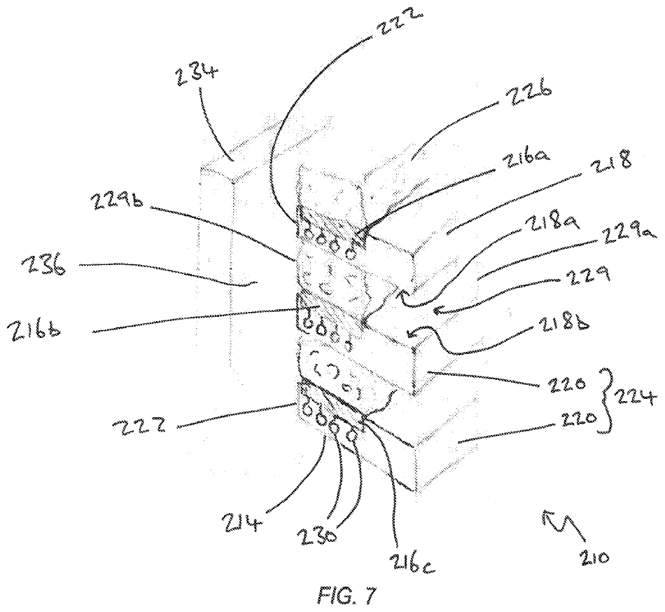

FIGS. 6 and 7 illustrate second and third embodiments of cladding elements 110, 210 in accordance with the present invention, wherein the respective air filtration panels 114, 214 have alternative arrangements to the air filtration panel 14 of the first embodiment shown in FIGS. 1 to 4. Features in common with the first embodiment of FIGS. 1 to 4 are indicated with corresponding numerals.

The cladding element 110 of FIG. 6 comprises an air filtration panel 114 comprising a plurality of shielding members 118 in the form of slats arranged substantially in the same manner as the shielding members 18 of FIGS. 1 to 4. The growing medium 116 is divided into a plurality of growing medium portions 116a, 116b, 116c, 116d, 116e, 116f, each of which is positioned between adjacent ones of the shielding members 118 and between the distal edges 120 and the proximal edges 122 of the shielding members 118. Accordingly, each growing medium portion 116a, 116b, 116c, 116d, 116e, 116f is recessed from the outer face 124 of the first side 114a of the air filtration panel 114, which outer face 124 is defined by the distal edges 120 of the shielding members 118. The exact position of the growing medium portions 116a, 116b, 116c, 116d, 116e, 116f relative to the distal edges 120 and proximal edges 122 of the shielding members is not critical, provided vegetation 126 growing thereon is recessed from the outer face 124 so as to be protected from solar radiation and wind, and may be chosen according to the particular requirements of the application. For example, where a greater degree of shielding is required (such as on a south-facing façade of the building), the growing medium portions 116a, 116b, 116c, 116d, 116e, 116f may be positioned further towards the proximal edges 122 of the shielding members, meaning that vegetation 126 growing thereon is further recessed from the outer face 124 and thus a greater degree of protection is obtained. The position of the growing medium portions 116a, 116b, 116c, 116d, 116e, 116f may be variable, enabling the air filtration panel 114 to be configured specifically for the particular application.

Each growing medium portion 116a, 116b, 116c, 116d, 116e, 116f extends in a plane which, in use, is substantially vertical and substantially parallel to the external façade of the building, however alternative orientations of the growing medium portions 116a, 116b, 116c, 116d, 116e, 116f are conceivable without deviating from the scope of the present invention.

Opposing surfaces 118a, 118b of each pair of adjacent shielding members 118 define a channel 129 between them, which channel 129 extends through the air filtration panel 114 and provides an airflow path from the first side 114a to the second side 114b. A first opening 129a of each channel 129 is defined by the two distal edges 120 of each pair of adjacent shielding members 118, the first opening 129a thus being located at the first side 124a of the air filtration panel. A second opening of each channel 129 is defined by the opposing proximal edges 122 of the respective shielding members 118. Each growing medium portion 116 is positioned, such that in use, air flowing through each channel 129 from the first opening 129a to the second opening 129b is directed through vegetation supported by the growing medium portions 116a-f.

Integrated into each of the shielding members 118 is a duct system 130 for water storage and/or transfer of water to the growing medium 116, thus providing an irrigation system of the cladding element 110. Water may be supplied to the growing medium 116 through the duct system 130 by pump action or under gravity. The duct system 130 of each cladding element is preferably capable of being coupled to a duct system of an adjoining cladding element, such that multiple cladding elements may be irrigated simultaneously and from the same water supply. Water may be supplied from a mains water supply or from a dedicated water tank. In preferred embodiments, each cladding element 110 comprises a tank (not shown) fluidly coupled to the ducts 130 and arranged to collect and store rainwater and to provide said water to the growing medium 116 via the duct system 130. The duct system 130 may also provide necessary drainage to allow excess water to be drained away from the growing medium so as to prevent the growing medium or the vegetation from becoming overly saturated. The irrigation system described above with respect to the embodiment of FIG. 6 may equally be incorporated into the embodiment of FIGS. 1 to 5. Further embodiments of the present invention may comprise an irrigation system for supplying water to the growing medium which is not integrated into the shielding members.

With reference to FIG. 7, there is shown a further embodiment of a cladding element 210 in accordance with the present invention, the cladding element 210 comprising an air filtration panel 214 comprising a plurality of shielding members 218 in the form of slats arranged substantially in the same manner as the shielding members 218 of the embodiments shown in FIGS. 1 to 6. The growing medium 216 is divided into a plurality of growing medium portions 216a, 216b, 216c, which are integrated into the shielding members 218. That is to say, each of the growing medium portions 216 is set into a surface 232 of a respective shielding member 218. Accordingly, vegetation 226 growing on each of the growing members 216 is able to fill the gaps between adjacent shielding members 218, such that airflow through the air filtration panel 214 between each pair of adjacent shielding members 218 is directed through the vegetation 226. Thus, whilst the growing medium 216 itself does not block the path of airflow through the air filtration panel 214, said airflow is still directed through the vegetation 226. Such an arrangement may be particularly suitable where the growing medium 216 is not air permeable or is insufficiently air permeable.

Opposing surfaces 218a, 218b of each pair of adjacent shielding members 218 define a channel 229 between them, which channel 229 extends through the air filtration panel 214 and provides an airflow path from the first side 214a to the second side 214b. A first opening 229a of each channel 229 is defined by the two distal edges 220 of each pair of adjacent shielding members 218, the first opening 229a thus being located at the first side 224a of the air filtration panel. A second opening of each channel 229 is defined by the opposing proximal edges 222 of the respective shielding members 218. Each growing medium portion 216 is positioned, such that in use, air flowing through each channel 229 from the first opening 229a to the second opening 229b is directed through vegetation supported by the growing medium portions 216a-f.

Each shielding member 218 comprises a duct system 230 forming at least part of an irrigation system of the cladding element 210, in the manner described above in relation to FIG. 6.

Whilst in each of the embodiments illustrated in FIGS. 1 to 7 and described above the growing medium 16, 116, 216 and thus the vegetation 26, 126, 226 growing thereon is recessed from the outer face 24, 124, 224 of the air filtration panel 14, 114, 214 by the provision of shielding members 18, 118, 218 which define channels 29, 129, 229, it will be appreciated that, in alternative embodiments, this effect may be achieved by other configurations of the air filtration panel. For example, the air filtration panel may be formed as a unitary panel having an outer surface defining the outer face of the first side of the air filtration panel. The channels may be formed within the unitary panel, the growing medium being positioned such that the growing medium and any vegetation growing thereon is recessed from the outer face of the unitary panel.

Referring now to each of the embodiments illustrated in FIGS. 1 to 7, the cladding element 10, 110, 210 further comprises a backing panel 34, 134, 234 which is spaced apart from the air filtration panel 14, 114, 214 and is substantially parallel to the plane of the air filtration panel 14, 114, 214. In the illustrated embodiment, the backing panel 34, 134, 234 is attached directly to a structural element of the building, such as a floor, so as to define a wall of the building to which the cladding element 10, 110, 210 is attached. In alternative embodiments, the backing panel may be attached to an existing wall of the building. The backing panel preferably provides insulation and weatherproofing to the building.

The gap between the backing panel 34, 134, 234 and the air filtration panel 14, 114, 214 defines an airflow passage 36, 136, 236 which extends from a bottom edge 38, 138, 238 of each cladding panel 10, 110, 210 to a top edge 40, 140, 240 of each cladding panel 10, 110, 210.

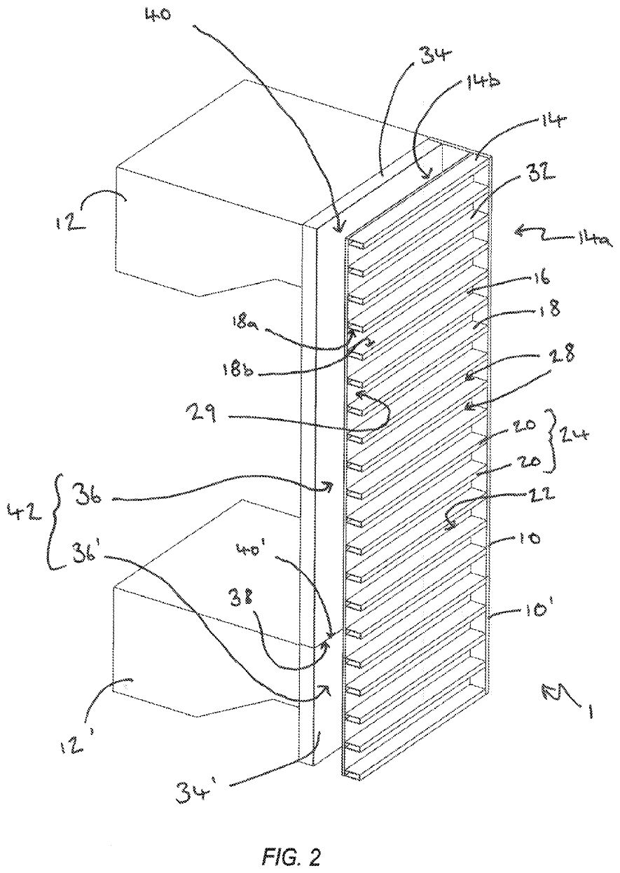

As shown most clearly in FIGS. 2 and 4, when two adjoining cladding elements 10, 10′ are assembled together, the bottom edge 38 of a first of the cladding elements 10 engages with a top edge 40′ of the adjoining cladding element 10′ in a manner which permits the two airflow passages 36, 36′ of the respective cladding elements 10, 10′ to be in fluid communication. Accordingly, when a series of cladding elements 10, 10′ are assembled together to form a building cladding assembly 1, as shown in FIG. 4, the airflow passages 36, 36′ combine to form a shaft 42 extending in a vertical direction from the bottom of the cladding assembly 1 to the top thereof.

In use, warm air is transferred to the shaft 42. This may be due to heat radiating from the building interior through the backing panels 34, 34′ of the cladding elements 10, 10′ or from warm ventilated air being channelled from the building into the shaft 42, for example from the exhaust of an air conditioning system. Warm air within the shaft 42 naturally rises upwards through the shaft 42, creating a passive convection current. This convection current in turn draws air through the air filtration panels 14, 14′ from the first side 14a to the second side 14b thereof. Accordingly, air is drawn through the vegetation 26, enabling the vegetation to perform its filtering function. Advantageously, the cladding assembly 1 is therefore able to provide a passive form of air filtration, without the requirement of any mechanical ventilation to generate are flow through the air filtration panels 14, 14′.

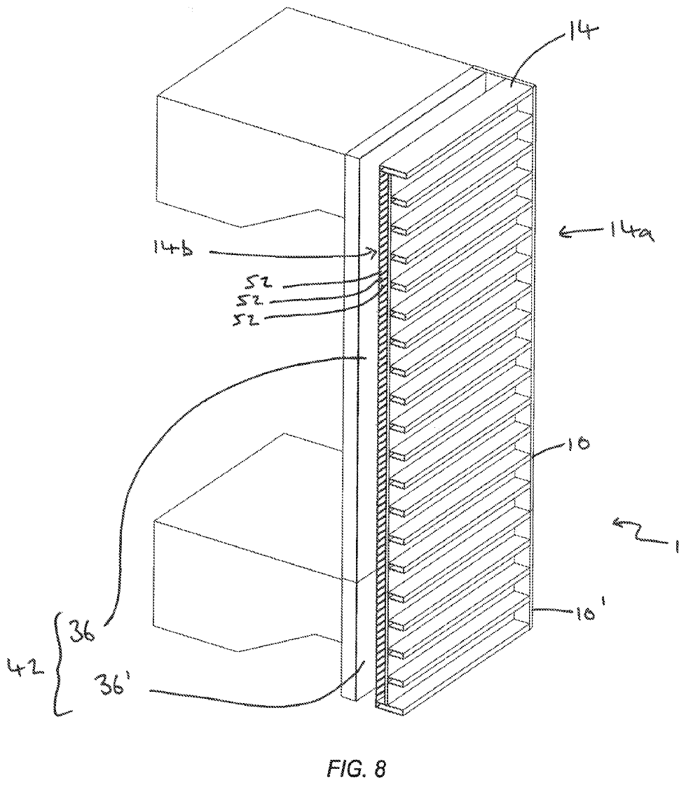

The build-up of warm air within the shaft may, in some instances, be detrimental to the vegetation supported by the growing mat, depending on the particular vegetation and the temperature of the air within the shaft. FIG. 8 shows a cladding element 10 substantially in accordance with the embodiment of FIGS. 1 to 4, with common features being indicated with like numerals, which is modified to prevent damage to the vegetation which may result from the collection of warm air within the shaft 42. In the embodiment of FIG. 8, the air filtration panel 14 comprises a thermally protective layer in the form of heat sink 50, which defines the second side 14b of the air filtration panel 14. The airflow passage 36 of the cladding element 10 is therefore defined by the backing panel 34 and the heat sink 50. The heat sink 50 is positioned between the rear surface of the growing medium 16 and the airflow passage 36, such that, in use, the heat sink 50 protects the growing medium 16 from the potentially high temperatures within the shaft 42 by dissipating heat from the shaft away from the growing medium 16, and thus any vegetation supported thereon.

The heat sink 50 may be formed of a thermally conductive material, such as aluminium, copper or alloys thereof. In the illustrated embodiment, the heat sink 50 comprises a plurality of louvres 52, which project away from the rear surface of the growing mat 16 at an oblique angle. The adjacent louvres 52 are spaced in a substantially vertical direction, in use, thus permitting air flow through the air filtration panel 14 and into the shaft 42. Numerous alternative arrangements of the heat sink 50 that provide a relatively large surface area, whilst also permitting airflow through the heat sink 50 into the shaft 42, may be used.

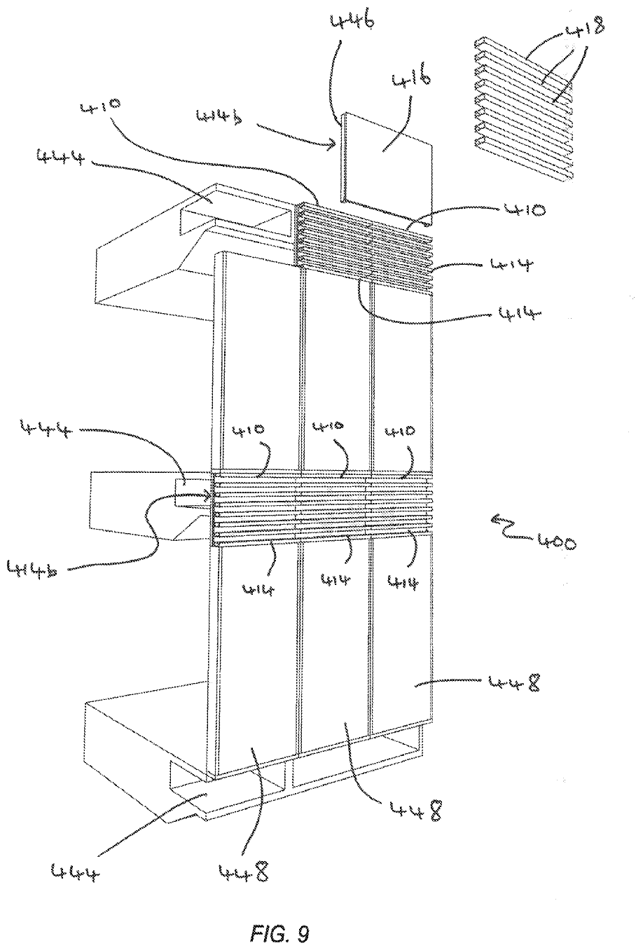

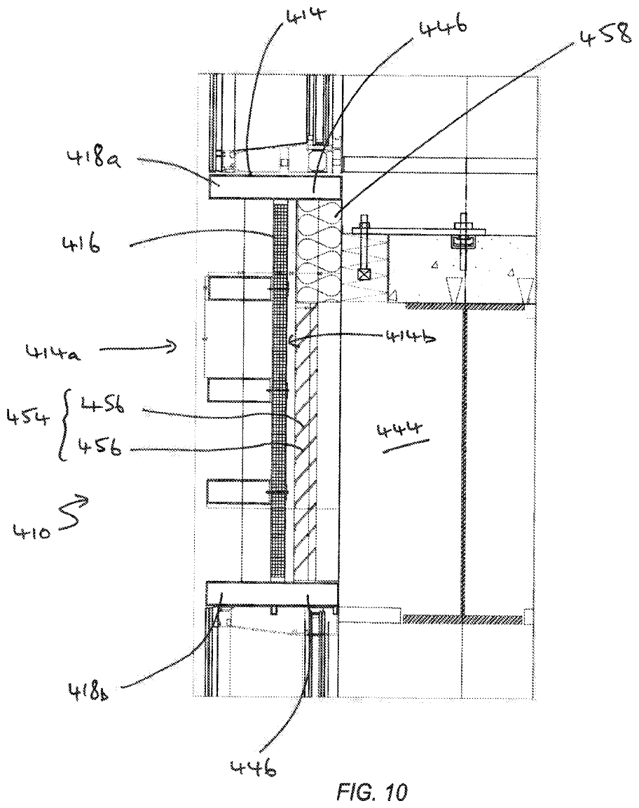

A fourth embodiment of the present invention is illustrated in FIGS. 9 and 10, which shows a building cladding system, indicated generally as 400, comprising a plurality of cladding elements 410. Features in common with the embodiment of FIGS. 1 to 5 are indicated with corresponding numerals. Each cladding element 410 comprises an air filtration panel 414 having substantially the same construction as the air filtration panel 14 of the first embodiment, as illustrated in FIGS. 1 to 5. The air filtration panel 414 comprises a growing medium 416 and a plurality of shielding members 418 for shielding vegetation (not shown) from solar radiation and wind.

In contrast to the cladding element 10 of the first embodiment, the cladding element 410 of the fourth embodiment does not comprise a backing panel. Instead, the second side 414b of the air filtration panel 414 remains substantially exposed. Accordingly, the cladding element 410 can be mechanically fixed to the building structure in a position in which the second side 414b of the air filtration panel 414 is in direct fluid communication with an air intake 444 of the building, which may be connected to the ducting of an air circulation system of the building, such as a heating or air conditioning system. Accordingly, the ventilation pull of the air intake 444 produces the necessary airflow through the air filtration panel 414. This provides the advantage of utilising existing air intakes of the building to generate air flow through the air filtration panel 414, without the need for a dedicated mechanical ventilation system. The air filtration panel 414 is spaced from the air intake 444 by spacers 446 projecting beyond the rear surface of the growing medium 416 in the direction of the building to which the cladding element 410 is attached.

FIG. 10 shows a variation of the cladding element 410, also configured to be fitted directly to an air intake 444 of the building. The uppermost and lowermost shielding members 418a, 418b project beyond the rear surface of the growing medium 416 in the direction of the building to which the cladding element 410 is attached, thus providing spacers 446 acting to space the air filtration panel 414 from the air intake 444 of the building.

To protect against ingress of rainwater and/or airborne detritus into the air intake 444, the cladding element 410 comprises a screen 454, which in the illustrated embodiment is in the form of louvres 456 sized, shaped and positioned to cover substantially the entire opening of the air intake 444. The screen 454 is provided rearward of the second side 414b of the air filtration panel 414, such that it is positioned in between the air filtration panel 414 and the air intake 444. The louvres 456 are arranged to extend substantially horizontally, in use, across the width of the air intake 444 and are angled downwardly away from the air intake 444, thus permitting air flow through the screen 454 from the air filtration panel 414 into the air intake 444 but inhibiting the ingress of rainwater and/or airborne detritus into the air intake 444. It will be appreciated that the exact shape, dimensions and position of the screen 454 will depend on the size and shape of the particular air intake 444 with which the cladding element 410 is intended to be fitted.

The cladding element 410 of FIG. 10 further comprises an insulation block 458 arranged, in use, to fill the remaining area between the air filtration panel 414 and the building.

Referring again to FIG. 9, the building cladding assembly 400 further comprises a plurality of blank cladding elements 448. The blank cladding elements 448 may be of any conventional type, such as single or double skin cladding and may be formed of any appropriate material such as timber, metal (e.g. aluminium), glass, concrete or a composite material. Numerous types of suitable cladding will be known to the skilled person. Each blank cladding element 448 is arranged to releasably engage with a respective cladding element 410 at a top or bottom edge of the cladding element 410. Importantly, the cladding elements 410 and the blank cladding elements 448 are arranged to be releasable engaged in situ. That is to say, the cladding elements 410 may be removed or inserted from or into the building cladding assembly 400 whilst the building cladding assembly 400 as a whole is fitted to a building. Accordingly, the building cladding assembly 400 may be initially installed using only blank cladding elements 448, which are of any conventional type. Thus, the building will initially have a conventional cladding. However, cladding elements 410 may later be ‘swapped-in’ by removing one or more of the blank cladding elements 448 and replacing these with one or more cladding elements 410 to provide an air filtration function . This permits a building developer to construct the building with a conventional type of cladding, perhaps to avoid incurring the additional cost of the more complicated cladding elements 410, but to retain the option to later install one or more cladding elements 410 according to the present invention.

It will be appreciated that the building cladding assemblies described above with reference to FIGS. 1 to 8 may also comprise blank cladding elements as described with reference to FIGS. 9 and 10.

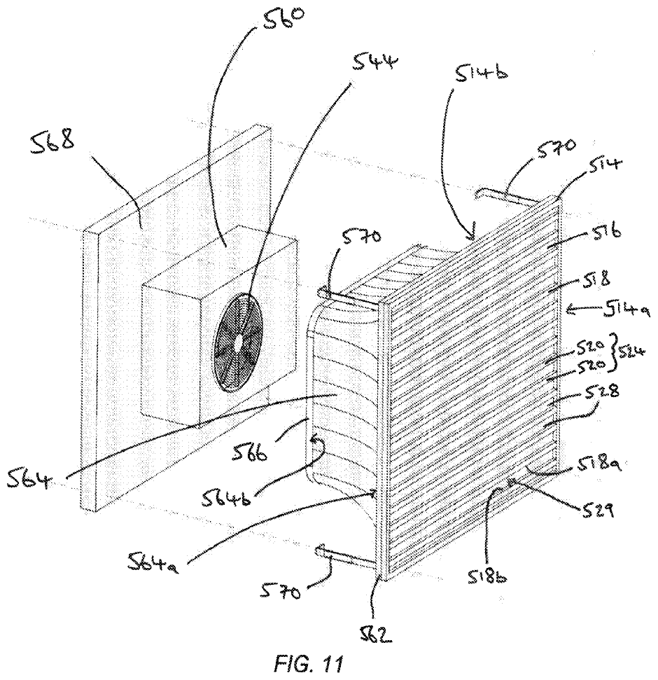

A fifth embodiment of a cladding element 510 in accordance with the present invention is illustrated in FIG. 11. The cladding element 510 is configured to be retrofitted to an external air conditioning unit 560 having an air inlet/outlet 544, such as a typical domestic air conditioning unit fitted externally to a wall of the building. The cladding element 510 could be used as a standalone building cladding system arranged to cover just the air conditioning unit 560, or could be used in combination with other identical or non-identical cladding elements to form a larger building cladding system covering a wider area of the building façade.

The cladding element 510 comprises an air filtration panel 514 having a growing medium 516 and a plurality of shielding members 518, the distal edges 520 of which define an outer face 524 of the air filtration panel 514. The shielding members 518 and the growing medium 516 collectively define a plurality of elongate recesses 528 in the air filtration panel 514, in which vegetation (not shown) can be grown. As for the embodiments described above with reference to FIGS. 1 to 10, vegetation grown within the elongate recesses 528 is recessed (i.e. set back from) the outer face 524 of the air filtration panel 514 and is therefore shielded from solar radiation and wind.

In the illustrated embodiment the growing medium 516 is in the form of a unitary growing mat and the shielding members 518 are arranged to extend horizontally across the outer face 524 of the air filtration panel. However, it will be appreciated that the air filtration panel 514 may have any suitable configuration in accordance with the present invention, such as in the embodiments of the air filtration panel hereinbefore described with reference to FIGS. 1 to 10.

Opposing surfaces 518a, 518b of each pair of adjacent shielding members 518 define a channel 529 between them, which channel 529 extends through the air filtration panel 514 and provides an airflow path from the first side 514a to the second side 514b. The growing medium portion 516 is positioned, such that in use, air flowing through each channel 529 from the first side 514a to the second side 514b is directed through vegetation supported by the growing medium portions 516a-f.

The air filtration panel 514 comprises a frame structure 562 defining a peripheral edge of the air filtration panel 514. The frame 562 encases the growing medium 516 and shielding members 518. A surround 564 extends between the frame 562 and the external wall 568. A distal edge 564a of the surround 564 sealing engages with the frame around the entire periphery of the second side 514b of the air filtration panel 514. A proximal edge 564b of the surround comprises a sealing member 566, which sealing member 566 is arranged to form a seal with an external wall 568 of the building to which the cladding element 510 is attached. In use, the surround 564 provides an airtight barrier around the second side 514b of the air filtration panel 514 and the air intake 544, such that air drawn in through the air intake 544 of the air conditioning unit 560 is drawn through the air filtration panel 514 from the first side 514a to the second side 514b.

The surround 564 is a flexible member arranged to expand and contract in a direction substantially perpendicular to the respective planes of the air filtration panel 514 and the external wall 568 of the building to which the cladding element 510 is attached. Accordingly, the depth of the cladding element 510 can be varied according to the size of the particular air conditioning unit 560. The cladding element 510 further comprises a plurality of adjustable brackets 570 for fixing the cladding element 510 to the external wall 568. The length of the brackets 570 can be adjusted to provide the necessary depth to permit the air conditioning unit 560 to be completely enclosed within the cladding element 510, when the cladding element 510 is fixed to the external wall 568.

According to the arrangement of the fifth embodiment, the external air conditioning unit 560 may be used to provide the necessary ventilation through the air filtration panel 514, without the need for dedicated mechanical ventilation. The cladding element 510 has the particular advantage of being able to be retrofitted to buildings in urban environments having externally mounted air conditioning units and thus may be particularly useful in urban domestic environments.

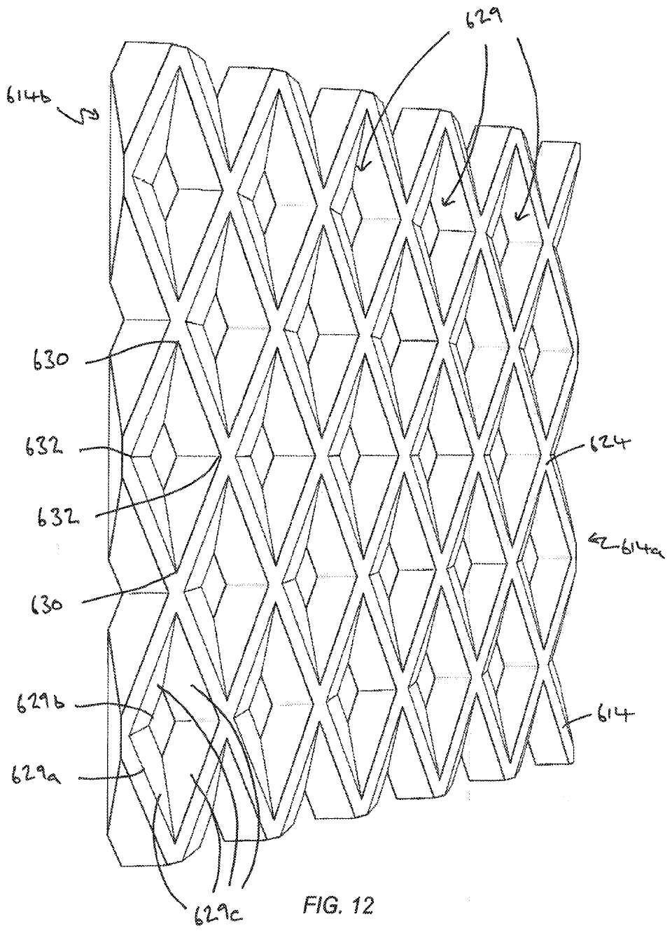

Further arrangements of an air filtration panel in accordance with the present invention are illustrated in FIGS. 12 to 15.

FIG. 12 shows an air filtration panel 614 for use with a cladding element in accordance with a further embodiment of the present invention. The air filtration panel 614 is formed as a unitary structure, for example by casting from a cementitious material. The air filtration panel 614 has an outer face 624 which, in use, defines a first side 614a of the air filtration panel 614 (i.e. the outer face 624 faces outwardly, away from the building in use).

The air filtration panel 614 comprises a plurality of channels 629, each having a first opening 629a located at the first side 614a of the air filtration panel 614, a second opening 629b, which in use will be located at or proximal to a second side 614b of the air filtration panel 614, and internal walls 629c extending between the first opening 629a and the second opening 629b. In use, each channel 629 defines an airflow path from the first side 614a of the air filtration panel 614 to the second side 614b of the air filtration panel 614.

Each of the internal walls 629c is substantially linear between the first opening 629a and the second opening 629b, however it will be appreciated that in other embodiments the internal walls of the channel may not follow a linear path and may be curved or undulating, for example.

Each of the first opening 629a and second opening 629b are in the form of a rhombus, having two opposing corners 630 aligned in a vertical direction and two opposing corners 631 aligned in a horizontal direction. The first opening 629a is larger than the second opening 629b, thus promoting air flow through the channel from the first opening 629a to the second opening 629b.

In use, a growing medium (not shown) is positioned such that vegetation supported on the growing medium is recessed from the outer face 624, and such that air flow from the first opening 629a to the second opening 629b is directed through and across the vegetation. The growing medium may be a separate substrate attached at the rear of the second opening 629b of each channel 629 (in a similar manner to the growing medium 16 of the first embodiment illustrated in FIGS. 1 to 4) or on the internal walls 629c of each channel 629. Alternatively, the internal walls 629c of the air filtration panel 629 may be formed of an appropriate material to act as a growing medium for supporting the growth of vegetation thereon.

The air filtration panel 614 may be affixed to a building structure by any appropriate means.

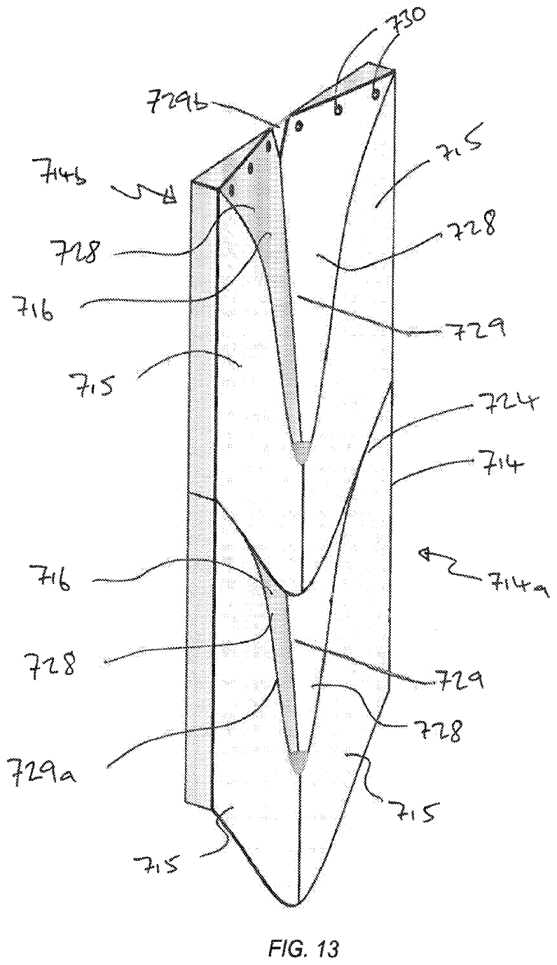

FIG. 13 shows a further air filtration panel 714 made up of a plurality of interconnecting tiles 715. Each tile 715 is formed as a unitary structure and is shaped to be interconnected with three further tiles to form the air filtration panel 714. It will be appreciated that other embodiments may use different numbers of tiles to form a complete air filtration panel.

Each tile 715 comprises a recessed portion 728 which combines with a corresponding recessed portion 728 of an adjacent tile 715 to form a channel 729 having a first opening 729a at a first side 714a of the air filtration panel 714, and a second opening 729b at the second side 714b of the air filtration panel 714 and internal walls 729c. An upper channel 729 of the air filtration panel 714 is shown in an open configuration to permit the second opening 729b to be seen.

It will be appreciated that the air filtration panel 714 can be extended by addition of further tiles 715 to provide a desired number of channels 729. In use, a growing medium 716 is provided on each recessed portion 728 such that vegetation supported by the growing medium is recessed from an outer face 724 of the air filtration panel 714.

Each tile 715 is provided with a plurality of fixing points 730 for fixing the tiles to an external façade of a building.

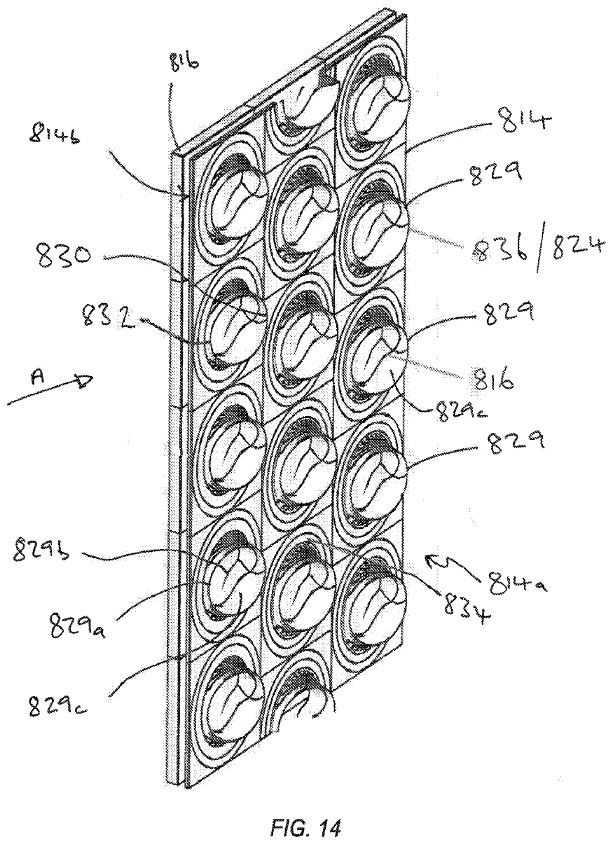

FIG. 14 shows a further air filtration panel 814 in accordance with the present invention, having a first side 814a facing outwardly from an external wall 816 of a building and a second side 814b facing towards the external wall 816 of a building. The air filtration panel 814 may be attached to the external wall 816 by any appropriate means, such as a fixing bracket.

The air filtration panel 814 comprises a plurality of channels 829 providing an airflow path from the first side 814a to the second side 814b of the air filtration panel 814. Each channel 829 comprises a first opening 829a at the first side 814a of the air filtration panel 814 and a second opening 829b at the second side 814b of the air filtration panel 814. An internal wall 829c extends between the first opening 829a and second opening 829b so as to provide an airflow path from the first side 814a to the second side 814b of the air filtration panel 814.

As can be seen, the first opening 829a of each channel 829 has a first side edge 830 and a second side edge 832 opposing the first side edge 830 in a lateral direction (that is, a generally horizontal direction in use). The first side edge 830 projects further than the second side edge 832 in a direction perpendicular to the plane of the external wall 816 of the building (i.e. in a direction away from the building). Accordingly, wind flow which passes across an outer face 824 of the air filtration panel 814 in a general direction from the second side edge to the first side edge (i.e. in the direction indicated by arrow A in FIG. 14) will be captured by the protruding first side edge 830 and thus directed through the channel 829.

It will be appreciated that the channels 829 shown in FIG. 14 could be rotated about 180 degrees in a plane parallel to the external wall 816 of the building so as to capture lateral wind flow passing across the outer face 824 of the air filtration panel 814 in the opposing lateral direction. Similarly, the channels 829 could be rotated 90 degrees in either direction in a plane parallel to the external wall 816 of the building so as to capture vertical wind flow in either an upward or downward direction. In some embodiments, the air filtration panel may comprise a plurality of channels with different orientations such that a single air filtration panel can capture wind flow in multiple lateral and vertical directions.

Whilst the channels 829 are shown in FIG. 14 to have a first opening 829a which is generally circular, it will be appreciated that the above effect can be achieved with an opening of any shape in which a first edge portion of the channel opening is arranged to project away from the building further than an opposing second edge portion.

Each channel 829 projects outwardly from a substantially planar support portion 834. Each channel 829 has a rim 836 defining the first opening 829a, which rims 836 also represent the outermost points of the air filtration panel 814. Accordingly, the rims 836 define the outer face 824 of the air filtration panel 814.

A growing medium 816 is provided on the inner walls 829c of each channel 829. Accordingly, vegetation grown on and supported by the growing medium 816 is recessed from the rim 836 defining the first opening 829a, and thus is recessed from the outer face 824 of the air filtration panel 814.

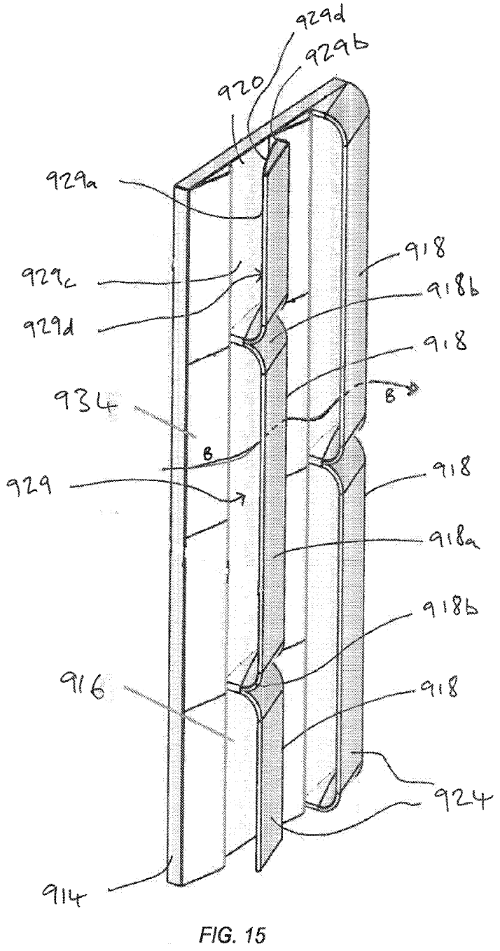

FIG. 15 shows an air filtration panel 914 in accordance with a further embodiment of the present invention. The air filtration panel 914 comprises a plurality of shielding members 918 spaced apart from a wall panel 920 which is arranged in use to lie substantially parallel to an external wall or façade of a building. Each shielding member 918 comprises an elongate slat 918a spaced from the wall panel 920 by shoulder portions 918b so as to define a channel 929 having a first opening 929a and a second opening 929b, a first inner surface 929c defined by the wall panel 920, the first inner surface 929c extending between the first opening 929a and the second opening 929b, and a second inner surface 929d defined by an inner surface of the elongate slat 918, the second inner surface 929d extending between the first opening 929a and the second opening 929b and opposing the first inner surface 929c.

In the illustrated embodiment, the first opening 929a and the second opening 929b of each channel 929 are opposed in a lateral direction (i.e. a generally horizontal direction, in use). Each channel 929 is thereby arranged to receive wind flow passing across an outer face 924 in a lateral direction.

A growing medium 916 is provided on the first inner surface 929c defined by the wall panel 920. A further growing medium (not shown) may also be optionally provided on the second inner surface 929d of the channel 929. Accordingly, airflow through the channel 929 is directed through or across vegetation supported by the growing medium 916. An outer surface of each elongate slat 918a defines the outer face 924 of the air filtration panel 914. Accordingly, the growing medium 916 is positioned such that any vegetation supported thereon is recessed from the outer face 924 of the air filtration panel 914. The shielding member 918 thereby shields vegetation from solar radiation.

The second inner surface 929d of each channel 929 lies at an oblique angle relative to the first inner surface 929c. Accordingly, airflow through the channel 929 is directed towards the first inner surface 929c and the vegetation growing thereon. To promote airflow through the channel 929, the second inner surface 929d of the channel has a convex shape. To achieve this, the elongate slat 918a may have an aerofoil form, with generally curved, convex surfaces on each opposing side of the elongate slat 918a.

To further promote airflow, the wall panel 920 comprises an airflow guiding portion 934 positioned adjacent the first opening 929a of the channel 929, which is arranged to guide airflow into the first opening 929a. The airflow guiding portion 934 has a generally convex shape, with its widest portion defining an edge of the first opening 929a. Accordingly, lateral wind flow across the air filtration panel 914 is guided by the airflow guiding portion generally away from the wall panel 920, into the first opening 929a of the channel 929, and then back towards the wall panel 920 by the second inner surface 929d of the channel. As can be seen in FIG. 15, a series of alternating airflow guiding portions 934 and channels 929 extending laterally across a building façade can therefore direct lateral wind flow across the building façade in an undulating fashion (as indicated by arrow B), so as to maximise the exposure of air to vegetation and thus maximise the efficacy of the air purification.

To further enhance air purification, a growing medium (not shown) may be provided on the external surface of the airflow guiding portion. However, it will be appreciated that vegetation supported by any such growing medium would not be recessed from the first opening 929c of the channel 929 and would not be shielded by the shielding member 918 to any significant extent.

It will be appreciated that wind flow passing across the building façade in a vertical direction can similarly be captured if the first opening 929a and second opening 929b of the channel 929 were opposed in a vertical direction, in use.

Whilst the wall panel 920 is illustrated in FIG. 15 as a substantially continuous surface, it is envisaged that apertures or openings may be provided in the wall panel 920, which permit air flow to be guided by the channels 929, through the wall panel 920 and into a building to which the air filtration panel 914 is fitted, thus providing a passive ventilation system for the building.

The invention has been described above with reference to specific embodiments, given by way of example only. It will be appreciated that different arrangements of the system are possible, which fall within the scope of the appended claims.

1. A cladding element for a building cladding system, the cladding element comprising:
an air filtration panel, comprising:
at least one channel providing an airflow path from a first opening of the channel to a second opening of the channel; and
a growing medium arranged to support the growth of vegetation thereon,
wherein the growing medium is positioned such that, in use, airflow through the channel from the first opening to the second opening is directed through or across vegetation supported by the growing medium.

2. The cladding element, according to claim 1, wherein the growing medium is positioned such that, in use, said vegetation supported by the growing medium is recessed from an outer face of the air filtration panel, such that said vegetation is shielded in at least one direction.

3. (canceled)

4. The cladding element, according to claim 1, wherein the first opening of the channel has a first side edge and a second side edge opposing the first side edge, the channel being arranged such that, in use, the first side edge projects further than the second side edge in a direction perpendicular to the plane of an external wall of a building to which the cladding element is attached or which is defined by the building cladding system, and
wherein, in use, the first side edge and the second side edge are opposed in a lateral direction, or wherein, in use, the first side edge and the second side edge are opposed in a vertical direction.

5. (canceled)

6. The cladding element, according to claim 1, wherein the first opening of the channel has a dimension in at least one direction that is larger than the corresponding dimension of the second opening of said channel.

7. The cladding element, according to claim 1, wherein the air filtration panel further comprises at least one shielding member arranged, in use, to project at an oblique angle or at a right angle to a plane of an external wall of a building to which the cladding element is attached or which is defined by the building cladding system, wherein a distal edge of the at least one shielding member at least partially defines the outer face of the first side of the air filtration panel.

8. The cladding element, according to claim 7, further comprising at least two shielding members, wherein the channel is defined by opposing surfaces of two adjacent shielding members, wherein the distal edges of said adjacent shielding members in combination at least partially define the outer face of the first side of the air filtration panel.

9. The cladding element, according to claim 7, wherein the growing medium is positioned at or towards a proximal edge of the shielding member.

10. The cladding element, according to claim 7, wherein the shielding member comprises an elongate slat.

11. (canceled)

12. The cladding element, according to claim 1, wherein the channel comprises a first inner surface arranged to lie, in use, substantially parallel to a plane of an external wall of a building to which the cladding element is attached or which is defined by the building cladding system and a second inner surface opposing the first surface, which is arranged to lie at an oblique angle relative to the first inner surface.

13-14. (canceled)

15. The cladding element, according to claim 1, wherein the air filtration panel further comprises an airflow guiding portion adjacent the first opening of the channel, the airflow guiding portion being arranged to guide airflow into the first opening.

16. The cladding element, according to claim 1, wherein the channel extends through the air filtration panel and provides an airflow path from a first side of the air filtration panel to a second side of the air filtration panel, such that, in use, air flowing through the or each channel from the first side of the air filtration panel to the second side of the air filtration panel is directed through or across vegetation supported by the growing medium.

17. The cladding element, according to claim 16, further comprising a backing panel spaced apart from the second side of the air filtration panel so as to define an airflow passage between the air filtration panel and the backing panel.

18. The cladding element, according to claim 17, wherein the airflow passage extends from a bottom edge of the cladding element to a top edge of the cladding element.

19. The cladding element, according to claim 18, wherein the top edge and bottom edge of the cladding element are arranged to engage with a respective top edge or bottom edge of another identical cladding element, such that respective the airflow passages of the two cladding elements are in fluid communication.

20. The cladding element, according to claim 1, comprising one or more spacers for, in use, spacing the air filtration panel from a structural element of the building to which the cladding element is attached.

21. The cladding element, according to claim 16, further comprising a surround having a distal edge sealingly engaged with the second side of the air filtration panel around a periphery of the second side of the air filtration panel, the surround further comprising a proximal edge arranged, in use, to form a seal with an external wall of a building to which the cladding element is attached.

22. (canceled)

23. A building cladding system, comprising:
a first cladding element, according to claim 1, and
a second cladding element at a top, bottom or side edge of the first cladding element.

24. (canceled)

25. A method of providing air purification, comprising the steps of:
fitting a cladding element, according to claim 1 to a building, such that the cladding element forms or is adjacent to an external wall of the building; and
providing vegetation on the growing medium of the air filtration panel.

26. The method of providing air purification according to claim 25, further comprising the step of:
fitting the cladding element to the building so as to define an airflow passage between the second side of the air filtration panel and an external wall the building, or wherein the cladding element comprises a backing panel spaced apart from the second side of the air filtration panel so as to define an airflow passage between the air filtration panel and the backing panel.

27. The method of providing air purification according to claim 26, wherein the cladding element is a first cladding element and the airflow passage is a first airflow passage, the method further comprising the step of:
fitting a second cladding element to the building so as to define a second airflow passage between the second cladding element and an external wall the building, or wherein the second cladding element comprises a second airflow passage, and wherein the first and second cladding elements are arranged to engage such that the first and second airflow passages are in fluid communication and at least partially define an upwardly extending shaft; and
ventilating warm air from the building into the shaft.

28-31. (canceled)
